(19) United States
(12) Patent Application Publication
(10) Pub. No.: US 2022/0230361 A1
(43) Pub. Date: Jul. 21, 2022

(54) INFORMATION PROCESSING METHOD, AND ENCODING DEVICE

(71) Applicant: GUANGDONG OPPO MOBILE TELECOMMUNICATIONS CORP., LTD., Dongguan (CN)

(72) Inventor: Yuhu JIA, Dongguan (CN)

(21) Appl. No.: 17/691,095

(22) Filed: Mar. 9, 2022

Related U.S. Application Data
(63) Continuation of application No. PCT/CN2019/115935, filed on Nov. 6, 2019.

(51) Int. Cl. G06T 9/00; G06T 3/40; G06T 7/70; G06T 7/50

(52) U.S. Cl. CPC G06T 9/00; G06T 3/40; G06T 2207/10016; G06T 7/50; G06T 7/70

(57) ABSTRACT

Disclosed are an information processing method and an encoding device. In the information processing method performed by the encoding device, pieces of depth information and video frames are collected, where each piece of the depth information corresponds one of the video frames. The pieces of depth information and the video frames are jointly or separately encoded to obtain pieces of encoded information. The pieces of encoded information are written into at least one code stream, and the at least one code stream is sent to an encoding device such that the encoding device performs image processing on the basis of the pieces of encoded information.

### CROSS-REFERENCE TO RELATED APPLICATION(S)

This application is a continuation of International Application PCT/CN2019/115935, filed Nov. 6, 2019, the entire disclosures of which are incorporated herein by reference.

### TECHNICAL FIELD

The embodiments of the disclosure relate to image processing technologies, and particularly to an information processing method, an encoding device, a decoding device, a system, and a storage medium.

### BACKGROUND

At present, when video signals are transmitted, for improving the transmission speed thereof, the encoder is used to first perform video encoding on two-dimensional images collected by an image sensor and depth images collected by a depth camera, to form pieces of video encoded information, and send the pieces of video encoded information to a decoder. The decoder obtains the two-dimensional images and the depth images by decoding the pieces of video encoded information. As can be known that, in the related art, only the depth images are obtained at the encoding end for being encoded and transmitted, and then the depth images are utilized at the decoding end to convert the two-dimensional images into three-dimensional images. However, the actual amount of information obtained by the depth camera is far greater than the amount of information presented by the depth images. In the related art, only the depth images are encoded and transmitted, which reduces the information utilization rate.

### SUMMARY

The embodiments of the disclosure provide an information processing method, an encoding device and a decoding device.

The technical solutions of the embodiments of the disclosure can be implemented as follows.

The embodiments of the disclosure provide an information processing method, which is performed by an encoding device. The method includes: collecting pieces of depth information and video frames, where each piece of the depth information corresponds one of the video frames; obtaining pieces of encoded information by encoding the pieces of depth information and the video frames; and writing the pieces of encoded information into at least one code stream, and sending the at least one code stream to a decoding device, so that the decoding device performs image processing based on the pieces of encoded information.

The embodiments of the disclosure provide an information processing method, which is performed by a decoding device. The method includes: upon receiving at least one code stream carrying pieces of encoded information, decoding the at least one code stream to obtain pieces of depth information and video frames, where each piece of the depth information corresponds one of the video frames; and performing image processing on the video frames based on the pieces of depth information, to obtain target image frames, and synthesizing the target image frames into a video.

The embodiments of the disclosure provide an encoding device, where the encoding device includes: a depth information module, configured to collect pieces depth information; an image sensor, configured to collect video frames, where each piece of the depth information corresponds one of the video frames; and an encoder, configured to encode the pieces of depth information and the video frames to obtain pieces of encoded information, write the pieces of encoded information into at least one code stream, and send the at least one code stream to a decoding device, so that the decoding device performs image processing based on the pieces of encoded information.

### BRIEF DESCRIPTION OF THE DRAWINGS

FIG. 1 is a schematic flowchart of an information processing method performed by an encoding device provided by the embodiments of the disclosure;

FIG. 2 is a schematic flowchart of another information processing method performed by the encoding device provided by the embodiments of the disclosure;

FIG. 3 is a schematic flowchart of an information processing method performed by a decoding device provided by the embodiments of the disclosure;

FIG. 4 is a schematic flowchart of another information processing method performed by the decoding device provided by the embodiments of the disclosure;

FIG. 5 is a schematic flowchart of an information processing method performed by the encoding device and decoding device provided by the embodiments of the disclosure;

FIG. 6 is a first schematic structural diagram of the encoding device provided by the embodiments of the disclosure;

FIG. 7 is a second schematic structural diagram of the encoding device provided by the embodiments of the disclosure;

FIG. 8(a) is a first schematic structural diagram of the decoding device provided by the embodiments of the disclosure;

FIG. 8(b) is a second schematic structural diagram of the decoding device provided by the embodiments of the disclosure;

FIG. 8(c) is a third schematic structural diagram of the decoding device provided by the embodiments of the disclosure;

FIG. 8(d) is a fourth schematic structural diagram of the decoding device provided by the embodiments of the disclosure;

FIG. 9(a) is a fifth schematic structural diagram of the decoding device provided by the embodiments of the disclosure;

FIG. 9(b) is a sixth schematic structural diagram of the decoding device provided by the embodiments of the disclosure;

FIG. 9(c) is a seventh schematic structural diagram of the decoding device provided by the embodiments of the disclosure;

FIG. 9(d) is an eighth schematic structural diagram of the decoding device provided by the embodiments of the disclosure;

FIG. 10(a) is a first schematic structural diagram of an information processing system provided by the embodiments of the disclosure;

FIG. 10(b) is a second schematic structural diagram of the information processing system provided by the embodiments of the disclosure;

FIG. 10(c) is a third structural schematic diagram of the information processing system provided by the embodiments of the disclosure;

FIG. 10(d) is a fourth schematic structural diagram of the information processing system provided by the embodiments of the disclosure;

FIG. 11(a) is a fifth structural schematic diagram of the information processing system provided by the embodiments of the disclosure;

FIG. 11(b) is a sixth schematic structural diagram of the information processing system provided by the embodiments of the disclosure;

FIG. 11(c) is a seventh structural schematic diagram of the information processing system provided by the embodiments of the disclosure; and

FIG. 11(d) is an eighth schematic structural diagram of the information processing system provided by the embodiments of the disclosure.

### DETAILED DESCRIPTION OF PREFERRED EMBODIMENTS

The technical solutions in the embodiments of the disclosure will be clearly and comprehensively described below with reference to the accompanying drawings in the embodiments of the disclosure.

It should be understood that the specific embodiments described herein are only used to explain the disclosure, but not to limit it. In addition, it should be noted that, for the convenience of description, only the parts related to the disclosure are shown in the drawings.

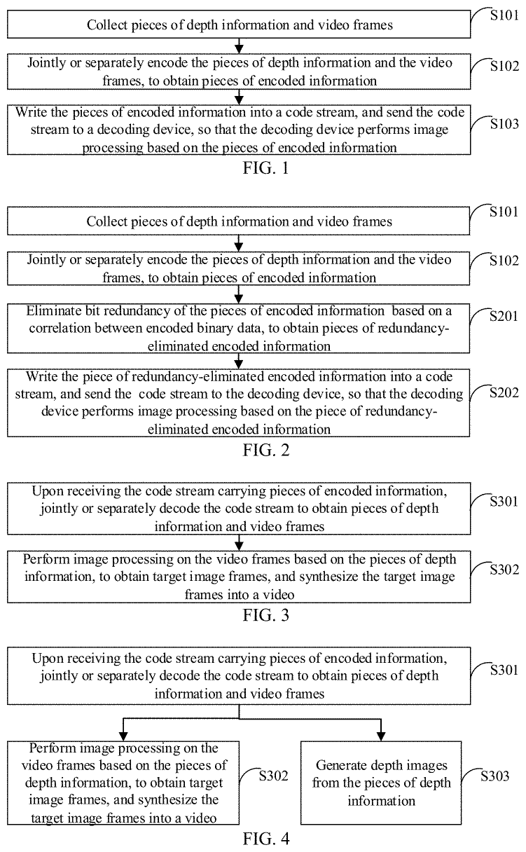

The embodiments of the disclosure provide an information processing method performed by an encoding device. As shown in FIG. 1, the information processing method includes operations as follows.

At block S101, pieces of depth information and video frames are collected.

The encoding device simultaneously collects the pieces of depth information and the video frames within a preset period of time. The video frames refer to multiple image frames collected within the preset period of time, where the multiple image frames constitute a video of preset period of time.

It should be noted that each piece of depth information corresponds to one image frame, i.e., one video frame, of the video frames.

In some embodiments, the encoding device collects the video frames within the preset period of time, and collects, through a time of flight (TOF) module, a binocular vision module or other depth information collection modules, pieces of initial depth information within the preset period of time, and takes the collected pieces of initial depth information as the pieces of depth information.

The encoding device uses an image sensor to collect the video frames, and at the same time, uses a depth information module to collect the pieces of initial depth information. The collected pieces of initial depth information are taken as the pieces of depth information. The depth information module includes the TOF module or the binocular vision module.

Exemplarily, the TOF module is a TOF camera. When the TOF camera is used to collect the pieces of initial depth information, the depth information module determines original charge images and/or sensor's attribute parameters (such as temperature) as the pieces of initial depth information. The original charge images can be acquired as follows: under two emission signals of different frequencies, by controlling the integration time, the depth information module obtains, though sampling, multiple groups of signals with different phases; and photoelectric conversion and then bit Quantization are performed on the multiple groups of signals, to generate multiple original charge images.

Exemplarily, the binocular vision module is a binocular camera. When the binocular camera is used to acquire the pieces of initial depth information corresponding to a target object, the depth information module captures two images with the binocular camera, and calculates disparity information and other information based on the poses of the two images. The depth information module takes the disparity information, camera's parameters and the like as the pieces of initial depth information.

In some embodiments, after the video frames are collected and the pieces of initial depth information are collected through the TOF module or the binocular vision module, the encoding device performs phase calibration on the pieces of initial depth information and obtains pieces of phase information, and takes the pieces of phase information as the pieces of depth information.

The depth information module in the encoding device performs phase calibration on the pieces of initial depth information and obtains pieces of phase information, and takes the pieces of phase information as the pieces of depth information. Alternatively, the depth information module performs other processing on the pieces of initial depth information to obtain other information, and takes the other information as the pieces of depth information.

Exemplarily, the phase information may be information on speckle, laser fringe, Gray code, sinusoidal fringe and the like obtained by the depth information module. The specific phase information may be determined according to the actual situation, which is not limited in the embodiments of the disclosure.

In some embodiments, after the video frames are collected and the pieces of initial depth information are collected through the TOF module or the binocular vision module, the encoding device performs depth image generation processing on the pieces of initial depth information to obtain depth images and pieces of remaining information. The pieces of remaining information are other information, excepting the depth images, that is produced in the process of generating the depth images. The pieces of remaining information and the depth images are taken as the pieces of depth information.

The depth information module in the encoding device generates the depth images based on the pieces of initial depth information, and acquires other information, excepting the depth images, that is produced in the process of generating the depth images, as the remaining information.

Exemplarily, after the original charge images are obtained using the TOF camera, the depth information module generates 2 pieces of process depth data and 1 piece of background data from the original charge images, and takes these 2 pieces of process depth data and 1 piece of background data as the depth information of the target object target.

At block S102, the pieces of depth information and the video frames are jointly or separately encoded to obtain pieces of encoded information.

The encoder in the encoding device performs joint encoding on the pieces of depth information and the video frames, to obtain pieces of information representing the pieces of depth information and the video frames, that is, pieces of hybrid encoded information. Alternatively, the pieces of depth information and the video frames are separately encoded by the encoder, to respectively obtain pieces of information representing the pieces of depth information and pieces of information representing the video frames, that is, pieces of depth encoded information and pieces of video encoded information.

In some embodiments, a video encoder in the encoding device utilizes a correlation between the video frames and the pieces of depth information to perform joint encoding on each piece of the depth information and one corresponding video frame, to obtain one piece of hybrid encoded information, thereby obtaining the pieces of hybrid encoded information composed of all pieces of the hybrid encoded information.

In some embodiments, the pieces of encoded information are pieces of hybrid encoded information, and the encoding device jointly encodes the pieces of depth information and the video frames based on the correlation between each of the pieces of depth information and a respective one of the video frames, to obtain the pieces of hybrid encoded information. Alternatively, the encoding device encodes the video frames to obtain pieces of video encoded information, encodes the pieces of depth information to obtain pieces of depth encoded information, and adds each of the pieces of depth encoded information to a preset position of a respective one of the pieces of video encoded information, to obtain the pieces of hybrid encoded information.

The encoder in the encoding device includes the video encoder, and the video encoder encodes the pieces of depth information based on a spatial correlation or temporal correlation of the pieces of depth information or the like, to obtain the pieces of depth encoded information, and encodes the video frames to obtain the pieces of video frame encoded information, and then combines the pieces of depth encoded information and the pieces of video frame encoded information to obtain the pieces of hybrid encoded information.

In some embodiments, the preset position may be an image information header, a sequence information header, an additional parameter set, or any other position.

Exemplarily, the video encoder in the encoding device encodes each piece of the depth information to obtain one piece of depth encoded information, encodes one corresponding video frame to obtain one piece of video frame encoded information, and then adds the piece of depth encoded information to the image information header of the corresponding piece of video frame encoded information to obtain one piece of hybrid encoded information. In this way, the pieces of hybrid encoded information composed of all pieces of the hybrid encoded information is obtained, where the pieces of video encoded information are composed of all pieces of the video frame encoded information.

Exemplarily, the video encoder in the encoding device encodes each piece of the depth information to obtain one piece of depth encoded information, encodes one corresponding video frame to obtain one piece of video encoded information, and adds the piece of depth encoded information to the sequence information header of the corresponding piece of video encoded information to obtain one piece of hybrid encoded information, thereby obtaining the pieces of hybrid encoded information composed of all pieces of the hybrid encoded information.

It should be noted that, since the piece of hybrid encoded information including the depth encoded information can be decoupled or be separated, after receiving the pieces of hybrid encoded information, the decoding device using the standard encoding and decoding protocol of video images can only extract the video frames from the pieces of hybrid encoded information, but does not extract the pieces of depth information; alternatively, it is also possible to extract only the pieces of depth information from the pieces of hybrid encoded information without extracting the video frames, which is not limited in the embodiments of the disclosure.

In some embodiments, the pieces of encoded information include pieces of depth encoded information and pieces of video encoded information, and the encoding device encodes the pieces of depth information to obtain the pieces of depth encoded information, and encodes the video frames to obtain the pieces of video encoded information.

The encoder in the encoding device includes a depth information encoder and the video encoder. The depth information encoder encodes the pieces of depth information based on the spatial correlation or temporal correlation or the like of the pieces of depth information, to obtain the pieces of depth encoded information. The video encoder encodes the video frames to obtain the pieces of video encoded information.

Specifically, the video encoder uses a video encoding and decoding protocol to encode the video frames to obtain the pieces of video encoded information. The video encoding and decoding protocol may be H.264, H.265, H.266, VP9, or AV1.

Specifically, the depth information encoder uses an industry standard or a specific standard of a specific organization to encode the pieces of depth information to obtain the pieces of depth encoded information.

In some embodiments, the encoding device performs reduction processing on the pieces of depth information to obtain pieces of reduced depth information, where the amount of data of the pieces of reduced depth information is less than the amount of data of the pieces of depth information; and the pieces of reduced depth information are encoded to obtain the pieces of depth encoded information.

The encoder in the encoding device performs the reduction processing on the pieces of depth information, so that the amount of data of the pieces of reduced depth information is less than the amount of data of the pieces of depth information, thereby reducing the workload of encoding the depth information.

In some embodiments, the encoding device selects, from the video frames, a part of video frames, and determines, from the pieces of depth information, a part of the pieces of depth information corresponding to the part of video frames. Alternatively, the encoding device determines, from the video frames, some image positions, and determines, from the pieces of depth information, a part of the pieces of depth information corresponding to the determined image positions. The determined part of the pieces of depth information is encoded to obtain the pieces of depth encoded information.

The encoding device may encode all the pieces of depth information, or encode only a part of the pieces of depth information corresponding to a part of the video frames, without encoding other part of the pieces of depth information corresponding to the other part of the video frames. Alternatively, the encoding device may only encode a part of each piece of depth information corresponding to at least one image position of each video frame, and the other part of the piece of depth information corresponding to the other positions of each video frame is not encoded. This is not limited in the embodiments of the disclosure.

In some embodiments, the encoding device performs redundancy elimination processing on the pieces of depth information based on a phase correlation of the pieces of depth information, a spatial correlation of the pieces of depth information, a temporal correlation of the pieces of depth information, a preset depth range, or a frequency domain correlation of the pieces of depth information, to obtain pieces of redundancy-eliminated depth information. The pieces of redundancy-eliminated depth information are taken as the pieces of reduced depth information.

In order to limit the size of the pieces of encoded information, the encoding device performs the redundancy elimination processing in the process of encoding the pieces of depth information, and then encodes the pieces of redundancy-eliminated depth information to obtain the pieces of depth encoded information.

Exemplarily, when the depth information module in the encoding device determines that the pieces of depth information include at least two pieces of phase information, it performs the redundancy elimination processing on the at least two pieces of phase information based on the phase correlation between the at least two pieces of phase information, to obtain the pieces of redundancy-eliminated depth information.

Alternatively, when it is determined that the pieces of depth information do not include the at least two pieces of phase information, the redundancy elimination processing is performed on the pieces of depth information based on the spatial correlation of the pieces of depth information, to obtain the pieces of redundancy-eliminated depth information.

Alternatively, when it is determined that the pieces of depth information do not include the at least two pieces of phase information, the redundancy elimination processing is performed on the pieces of depth information based on the temporal correlation of the pieces of depth information, to obtain the pieces of redundancy-eliminated depth information.

Alternatively, when it is determined that the pieces of depth information do not include the at least two pieces of phase information, the redundancy elimination processing is performed on the pieces of depth information based on the preset depth range, to obtain the pieces of redundancy-eliminated depth information.

Alternatively, when it is determined that the pieces of depth information do not include the at least two pieces of phase information, frequency domain conversion is performed on the pieces of depth information to obtain pieces of frequency domain information, and the redundancy elimination processing is performed on the pieces of frequency domain information based on the frequency domain correlation, to obtain the pieces of redundancy-eliminated depth information.

It should be noted that the preset depth range is a range within which the depth information sensor can collect the depth information.

In some embodiments, the encoding device collects the pieces of depth information and the video frames from at least one viewpoint, determines from the at least one viewpoint spaced viewpoints that are spaced from each other by one other viewpoint, and utilizes pieces of depth information corresponding to the spaced viewpoints as pieces of spaced depth information. The pieces of spaced depth information are jointly encoded with or separately encoded from the video frames, to obtain pieces of spaced encoded information. The pieces of spaced encoded information are sent to the decoding device, so that the decoding device performs the image processing based on the pieces of spaced encoded information. The viewpoint represents a shooting angle.

The encoding device deals information obtained from multiple viewpoints. Multiple pieces of depth information such as phase information or charge images, which are collected from the multiple viewpoints in a same scene at the same time, have strong correlations therebetween. In order to reduce the amount of the transmitted encoded information, only the pieces of depth information collected from the spaced viewpoints of the multiple viewpoints may be encoded and sent. After the decoding device obtains the pieces of depth information of the spaced viewpoints, pieces of depth information of other viewpoints, excepting the spaced viewpoints, of the multiple viewpoints may be generated based on the pieces of depth information of the spaced viewpoints of the multiple viewpoints.

Exemplarily, for 3-Dimension High Efficiency Video Coding (3D HEVC), the coding device often collects the pieces of depth information and the video frames from multiple viewpoints. The pieces of depth information corresponding to the spaced viewpoints of the multiple viewpoints and the video frames obtained from the multiple viewpoints can be jointly or separately encoded, to obtain the pieces of spaced encoded information. The pieces of spaced encoded information include information corresponding to both the pieces of depth information of the spaced viewpoints and the video frames obtained from the multiple viewpoints, or include information corresponding to the pieces of depth information of the spaced viewpoints and information corresponding to the video frames obtained from the multiple viewpoints.

Exemplarily, for three viewpoints in the same scene, the spaced viewpoints among the three viewpoints are the left and right viewpoints, and the middle viewpoint is the other viewpoint among the three viewpoints.

At block S103, the pieces of encoded information are written into at least one code stream, and the at least one code stream is sent to the decoding device, so that the decoding device performs image processing based on the pieces of encoded information.

The encoding device writes the pieces of encoded information into the code stream, and sends the code stream to the decoding device.

Exemplarily, the video encoder in the encoding device writes the pieces of hybrid encoded information into a hybrid code stream, and sends the hybrid code stream to the decoding device.

Exemplarily, the video encoder in the encoding device writes the pieces of video encoded information into a video encoded information code stream, and sends the video encoded information code stream to the decoding device. The depth information encoder in the encoding device writes the pieces of depth encoded information into a depth encoded information code stream, and sends the depth encoded information code stream to the decoding device.

In some embodiments, as shown in the flowchart of the information processing method shown in FIG. 2, after the operation S102, the information processing method further includes operations as follows.

At block S201, bit redundancy of the pieces of encoded information is eliminated based on a correlation between encoded binary data of the pieces of encoded information, to obtain pieces of redundancy-eliminated encoded information.

In order to limit the size of the pieces of encoded information, the encoding device performs the bit redundancy elimination operation after obtaining the pieces of encoded information, to obtain the pieces of redundancy-eliminated encoded information.

Exemplarily, after obtaining the pieces of depth encoded information, the depth information encoder in the encoding device eliminates the bit redundancy for the pieces of depth encoded information to obtain pieces of redundancy-eliminated depth encoded information. After obtaining the pieces of video encoded information, the video encoder in the encoding device eliminates the bit redundancy for the pieces of video encoded information, to obtain pieces of redundancy-eliminated video encoded information. The pieces of redundancy-eliminated depth encoded information and the pieces of redundancy-eliminated video encoded information constitute the pieces of redundancy-eliminated encoded information.

Exemplarily, after obtaining the pieces of hybrid encoded information, the video encoder in the coding device eliminates the bit redundancy for the pieces of hybrid encoded information, to obtain the piece of redundancy-eliminated encoded information.

At block S202, the piece of redundancy-eliminated encoded information are written into at least one code stream, and the at least one code stream is sent to the decoding device, so that the decoding device performs image processing based on the piece of redundancy-eliminated encoded information.

The video encoder in the encoding device writes the piece of redundancy-eliminated encoded information into a hybrid code stream, and sends the hybrid code stream to the decoding device. Alternatively, the video encoder in the encoding device writes the piece of redundancy-eliminated video encoded information into a video encoded information code stream, and sends the video encoded information code stream to the decoding device; and the depth information encoder in the encoding device writes the piece of redundancy-eliminated depth encoded information into a depth encoded information code stream, and sends the depth encoded information code stream to the decoding device.

It can be understood that the encoding device directly encodes the piece of depth information, to obtain the piece of encoded information representing the depth information, and sends the piece of encoded information to the decoding device. In this way, the decoding device can decode the pieces of depth information and the video frames from the piece of encoded information. Thus, the decoding device can not only generate depth images from the pieces of depth information, but also can utilizes the pieces of depth information to perform image processing on the video frames, which improves the information utilization rate.

The embodiments of the disclosure also provide an information processing method performed by the decoding device. As shown in FIG. 3, the information processing method includes operations as follows.

At block S301, upon receiving at least one code stream carrying pieces of encoded information, the at least one code stream is jointly or separately decoded to obtain pieces of depth information and video frames.

After receiving the at least one code stream, a decoder in the decoding device decodes the at least one code stream jointly or separately decoded to obtain the pieces of depth information and the video frames.

In some embodiments, the decoding device may also receive at least one code stream carrying the pieces of redundancy-eliminated encoded information, and decodes the at least one code stream carrying the pieces of redundancy-eliminated encoded information, to obtain the pieces of depth information and the video frames.

In some embodiments, the code stream is a hybrid encoded information code stream, and the decoding device decodes the hybrid encoded information code stream to obtain the pieces of depth information and the video frames.

The decoder in the decoding device includes a video decoder, and the video decoder decodes the pieces of hybrid encoded information to obtain the pieces of depth information and the video frames.

In some embodiments, the at least one code stream includes a video encoded information code stream and a depth encoded information code stream. The decoding device decodes the video encoded information code stream to obtain the video frames, and decodes the depth encoded information code stream to obtain the pieces of depth information.

The decoder in the decoding device includes the video decoder and a depth information decoder. The video decoder decodes the pieces of video encoded information to obtain the video frames. The depth information decoder decodes the pieces of depth encoded information to obtain the pieces of depth information.

At block S302, image processing is performed on the video frames based on the pieces of depth information, to obtain target image frames, and the target image frames are synthesized into a video.

When a depth assist function is enabled, the decoding device can use each piece of the depth information, such as the pieces of remaining information mentioned above, to perform image processing on a corresponding one of the video frames, to obtain one target image frame. When all the target image frames are obtained in this way, all the obtained target image frames are synthesized into a video for display.

In some embodiments, the decoding device uses the pieces of depth information to accordingly process the video frames according to default decoding requirements. Alternatively, in response to receiving a decoding instruction, the decoding device uses the pieces of depth information to accordingly process the video frames. The decoding instruction may be a depth-of-field setting instruction, an image enhancement instruction, or a background blurring (bokeh) instruction.

In some embodiments, the decoding device adjusts depths of field of the video frames based on the pieces of depth information, to obtain image frames with depth of field. The image frames with depth of field are taken as the target image frames.

In response to receiving the depth-of-field setting instruction, the image processor in the decoding device uses each piece of the depth information to perform the depth of field adjustment on a corresponding one of the video frames, to obtain an image frame with depth of field.

It should be noted that the pieces of depth information can be directly applied to the video frames to generate the image frames with depth of field, and it is not necessary to superimpose the depth images generated from the pieces of depth information with the video frames to generate the image frames with depth of field.

In some embodiments, when the pieces of depth information include pieces of phase information, the decoding device deblurs, based on the pieces of phase information, the video frames to obtain deblurred image frames, and takes the deblurred image frames as the target image frames.

In response to receiving the image enhancement instruction, the image processor in the decoding device analyzes each piece of the phase information to obtain an analysis result, and uses the analysis result to deblur a corresponding one of the video frames to obtain one deblurred image frame.

In some embodiments, when the pieces of depth information include pieces of phase information, the decoding device blurs, based on the pieces of phase information, the foreground or background of the corresponding video frames to obtain blurred image frames. The blurred image frames are taken as the target image frames.

In response to receiving the background blurring instruction and determining that the pieces of depth information include pieces of phase information, the image processor in the decoding device blurs, based on each piece of the depth information, the foreground or background of a corresponding one of the video frames to obtain one blurred image frame.

In some embodiments, when the pieces of depth information include pieces of charge information, the decoding device determines, based on the pieces of charge information, the noise and external visible light in the shooting scene from which the video frames are collected, which facilitates the denoising and white balance adjustment of the video frames, and enables a video of high quality to be generated for being displayed to the user, thereby improving the user's experience of viewing the images of the video.

In some embodiments, the decoding device jointly or separately decodes the pieces of spaced encoded information, to obtain the pieces of depth information corresponding to the spaced viewpoints and the video frames obtained from at least one viewpoint. A difference between the pieces of depth information corresponding to the spaced viewpoints is calculated, for obtaining pieces of depth information corresponding to other viewpoints of the at least one viewpoint excepting the spaced viewpoints. The image processing is performed on the video frames obtained from the at least one viewpoint based on the pieces of depth information corresponding to the spaced viewpoints and the pieces of depth information corresponding to other viewpoints, to obtain the target image frames.

Exemplarily, at least one frame is obtained from three viewpoints for the same scene, the spaced viewpoints among the three viewpoints are the left and right viewpoints, and the difference between the depth information of the left and right viewpoints may be calculated for obtaining the depth information of the middle viewpoint.

In some embodiments, as shown in the flowchart of an information processing method shown in FIG. 4, after the operation S301, the information processing method further includes operations as follows.

At block S303, depth images are generated from the pieces of depth information.

A depth image generator in the decoding device processes various pieces of the depth information to obtain the depth images.

In some embodiments, when the pieces of depth information include pieces of phase information, for alleviating the image blur caused by motion, multiple pieces of phase information collected at multiple time points within a preset period of time are used to perform motion estimation, to generate one depth image, where such depth image is clearer. In which, the generated one depth image is a depth image corresponding to one time point of the multiple time points, and the multiple time points may be consecutive.

It can be understood that, for the case where multiple pieces of phase information collected at different time points are required to generate one depth image, in the embodiments of the disclosure, the pieces of phase information within the preset period of time are encoded and transmitted, rather than making the depth images encoded and transmitted. As such, the decoding device can decode the code stream to obtain the pieces of phase information within the preset period of time, and then acquire, from the pieces of phase information within the preset period of time, multiple pieces of phase information corresponding to multiple time points, to use them to generate one depth image.

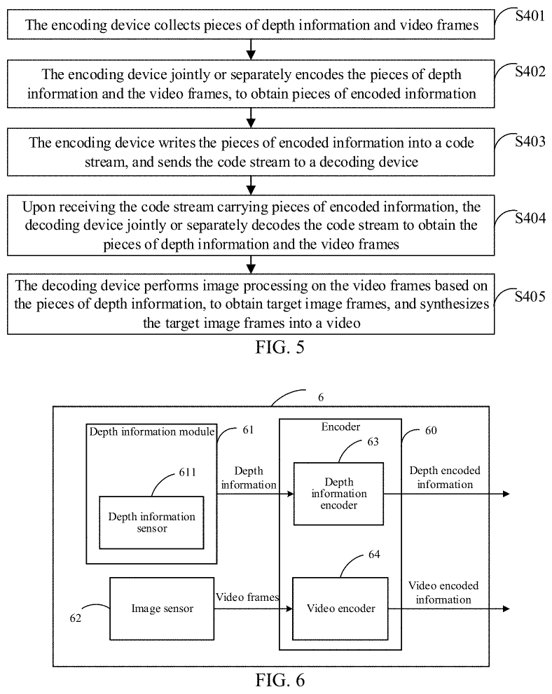

In some embodiments, an information processing system includes the encoding device and the decoding device, and an information processing method applied to the information processing system is schematically illustrated in the flowchart of an information processing method shown in FIG. 5. The information processing method includes operations as follows.

At block S401, the encoding device collects the pieces of depth information and the video frames.

At block S402, the coding device jointly or separately encodes the pieces of depth information and the video frames to obtain pieces of encoded information, where the pieces of encoded information includes information corresponding to both the pieces of depth information and the video frames, or includes information corresponding to the pieces of depth information and information corresponding to the video frames.

At block S403, the encoding device writes the encoded information into at least one code stream, and sends the at least one code stream to the decoding device.

At block S404, upon receiving the at least one code stream carrying the pieces of encoded information, the decoding device jointly or separately decodes the at least one code stream to obtain the pieces of depth information and the video frames.

At block S405, the decoding device performs image processing on the video frames based on the pieces of depth information to obtain target image frames, and synthesizes the target image frames into a video.

It can be understood that the decoding device receives the pieces of encoded information containing the pieces of depth information, so that the decoding device can decode, from the pieces of encoded information, the pieces of depth information and the video frames. On this basis, the decoding device can not only use the pieces of depth information to generate the depth images, but also use the pieces of depth information to perform optimization processing, such as depth-of-field adjustment and deblurring, on the video frames, which improves the information utilization rate. Also, the target image frames obtained after the optimization processing have a better image effect than the video frames, that is to say, this also enables the image quality to be improved.

The embodiments of the disclosure further provide an encoding device. As shown in FIG. 6, the encoding device 6 includes a depth information module 61, an image sensor 62, and an encoder 60.

The depth information module 61 is configured to collect pieces of depth information.

The image sensor 62 is configured to collect video frames.

The encoder 60 is configured to jointly or separately encode the pieces of depth information and the video frames, to obtain pieces of encoded information, write the pieces of encoded information into at least one code stream, and send the at least one code stream to the decoding device, so that the decoding device performs image processing based on the pieces of encoded information.

In some embodiments, the depth information module 61 includes a depth information sensor 611.

The image sensor 62 is further configured to collect the video frames within a preset period of time.

The depth information sensor 611 is configured to collect, through a time-of-flight module or a binocular vision module, pieces of initial depth information within the preset period of time, and take the pieces of initial depth information as the pieces of depth information.

In some embodiments, the depth information module 61 is further configured to, after the video frames are collected and the pieces of initial depth information are collected through the TOF module or the binocular vision module, performs phase calibration on the pieces of initial depth information and obtains pieces of phase information, and takes the pieces of phase information as the pieces of depth information.

In some embodiments, the depth information module 61 is further configured to: after the video frames are collected and the pieces of initial depth information are collected through the TOF module or the binocular vision module, perform depth image generation processing on the pieces of initial depth information to obtain depth images and pieces of remaining information. The pieces of remaining information are other information, excepting the depth images, that is produced in the process of generating the depth images. The depth information module is further configured to take the depth images and the pieces of remaining information as the pieces of depth information.

In some embodiments, the pieces of encoded information include pieces of depth encoded information and pieces of video encoded information. The encoder 60 includes a depth information encoder 63 and a video encoder 64.

The depth information encoder 63 is configured to encode the pieces of depth information to obtain the pieces of depth encoded information.

The video encoder 64 is configured to encode the video frames to obtain the pieces of video encoded information.

In some embodiments, the depth information encoder 63 is further configured to perform reduction processing on the pieces of depth information to obtain pieces of reduced depth information, where the amount of data of the pieces of reduced depth information is less than the amount of data of the pieces of depth information; and encode the pieces of reduced depth information to obtain the pieces of depth encoded information.

In some embodiments, the depth information encoder 63 is further configured to: select, from the video frames, a part of video frames, and determine, from the pieces of depth information, a part of the pieces of depth information corresponding to the part of video frames, and take the determined part of the pieces of depth information as the pieces of reduced depth information.

Alternatively, the depth information encoder is further configured to determine, from the video frames, at least one image position, and determine, from the pieces of depth information, a part of the pieces of depth information corresponding to the at least one image position, and take the determined part of the pieces of depth information as the pieces of reduced depth information.

In some embodiments, the depth information encoder 63 is further configured to perform redundancy elimination processing on the pieces of depth information based on a phase correlation of the pieces of depth information, a spatial correlation of the pieces of depth information, a temporal correlation of the pieces of depth information, a preset depth range, or a frequency domain correlation of the pieces of depth information, to obtain pieces of redundancy-eliminated depth information, and take the pieces of redundancy-eliminated depth information as the pieces of reduced depth information.

In some embodiments, when the pieces of depth information includes at least two pieces of phase information, the depth information encoder 63 is further configured to perform the redundancy elimination processing on the at least two pieces of phase information based on a phase correlation between the at least two pieces of phase information, to obtain the pieces of redundancy-eliminated depth information.

Alternatively, when the pieces of depth information do not include the at least two pieces of phase information, the depth information encoder is further configured to perform the redundancy elimination processing on the pieces of depth information based on the spatial correlation of the pieces of depth information, to obtain the pieces of redundancy-eliminated depth information.

Alternatively, when the pieces of depth information do not include the at least two pieces of phase information, the depth information encoder is further configured to perform the redundancy elimination processing on the pieces of depth information based on the temporal correlation of the pieces of depth information, to obtain the pieces of redundancy-eliminated depth information.

Alternatively, when the pieces of depth information do not include the at least two pieces of phase information, the depth information encoder is further configured to perform the redundancy elimination processing on the pieces of depth information based on the preset depth range, to obtain the pieces of redundancy-eliminated depth information.

Alternatively, when the pieces of depth information do not include the at least two pieces of phase information, the depth information encoder is further configured to perform frequency domain conversion on the pieces of depth information to obtain pieces of frequency domain information, and perform the redundancy elimination processing on the pieces of frequency domain information based on the frequency domain correlation, to obtain the pieces of redundancy-eliminated depth information.

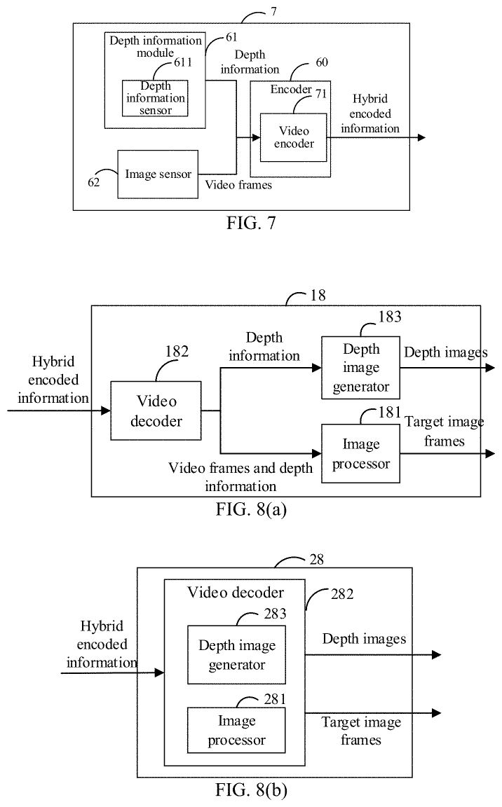

In some embodiments, the pieces of encoded information are pieces of hybrid encoded information. As shown in the schematic structural diagram of another encoding device shown in FIG. 7, the encoder 60 includes a video encoder 71.

The video encoder 71 is configured to jointly encode the pieces of depth information and the video frames based on the correlation between the pieces of depth information and the video frames, to obtain pieces of hybrid encoded information.

Alternatively, the video encoder is configured to encode the video frames to obtain pieces of video encoded information, encode the pieces of depth information to obtain pieces of depth encoded information, and add each piece of the depth encoded information to a preset position of a corresponding piece of the video encoded information, thereby obtaining the pieces of hybrid encoded information.

In some embodiments, the video encoder 71 is further configured to perform reduction processing on the pieces of depth information to obtain pieces of reduced depth information, where the amount of data of the pieces of reduced depth information is less than the amount of data of the pieces of depth information, and encode the pieces of reduced depth information to obtain the pieces of depth encoded information.

In some embodiments, the video encoder 71 is further configured to select, from the video frames, a part of video frames, and determine, from the pieces of depth information, a part of the pieces of depth information corresponding to the part of video frames, and take the determined part of the pieces of depth information as the pieces of reduced depth information.

Alternatively, the video encoder is further configured to determine, from the video frames, at least one image position, and determine, from the pieces of depth information, a part of the pieces of depth information corresponding to the at least one image position, and take the determined part of pieces of depth information as the pieces of reduced depth information.

In some embodiments, the video encoder 71 is further configured to perform redundancy elimination processing on the pieces of depth information based on a phase correlation of the pieces of depth information, a spatial correlation of the pieces of depth information, a temporal correlation of the pieces of depth information, a preset depth range, or a frequency domain correlation of the pieces of depth information, to obtain pieces of redundancy-eliminated depth information, and take the pieces of redundancy-eliminated depth information as the pieces of reduced depth information.

In some embodiments, when the pieces of depth information includes at least two pieces of phase information, the video encoder 71 is further configured to perform the redundancy elimination processing on the at least two pieces of phase information based on the phase correlation between the at least two pieces of phase information, to obtain the pieces of redundancy-eliminated depth information.

Alternatively, when the pieces of depth information do not include the at least two pieces of phase information, the video encoder is further configured to perform the redundancy elimination processing on the pieces of depth information based on the spatial correlation of the pieces of depth information, to obtain the pieces of redundancy-eliminated depth information.

Alternatively, when the pieces of depth information do not include the at least two pieces of phase information, the video encoder is further configured to perform the redundancy elimination processing on the pieces of depth information based on the temporal correlation of the pieces of depth information, to obtain the pieces of redundancy-eliminated depth information.

Alternatively, when the pieces of depth information do not include the at least two pieces of phase information, the video encoder is further configured to perform the redundancy elimination processing on the pieces of depth information based on the preset depth range, to obtain the pieces of redundancy-eliminated depth information.

Alternatively, when the pieces of depth information do not include the at least two pieces of phase information, the depth information encoder is further configured to perform frequency domain conversion on the pieces of depth information to obtain pieces of frequency domain information, and perform the redundancy elimination processing on the pieces of frequency domain information based on the frequency domain correlation, to obtain the pieces of redundancy-eliminated depth information.

In some embodiments, the encoder 60 is further configured to, after the pieces of encoded information are obtained by jointly or separately encoding the pieces of depth information and the video frames, eliminate bit redundancy of the pieces of encoded information based on a correlation between encoded binary data of the pieces of encoded information, to obtain pieces of redundancy-eliminated encoded information; and write the redundancy-eliminated encoded information into the at least one code stream, and send the at least one code stream to the decoding device, so that the decoding device performs the image processing based on the redundancy-eliminated encoded information.

The embodiments of the disclosure provide a computer-readable storage medium, which is applied to the encoding device. The computer-readable storage medium stores one or more programs, and the one or more programs can be executed by one or more first processors. When executed by the first processor, the above information processing method performed by the encoding device is implemented.

The embodiments of the disclosure also provide a decoding device, where the decoding device includes an image processor and a decoder.

The decoder is configured to, upon receiving at least one code stream carrying pieces of encoded information, jointly or separately decode the at least one code stream to obtain the pieces of depth information and the video frames.

The image processor is configured to perform image processing on the video frames based on the pieces of depth information to obtain target image frames, and synthesize the target image frames into a video.

In some embodiments, the at least one code stream includes a video encoded information code stream and a depth encoded information code stream. The decoder includes a video decoder and a depth information decoder.

The video decoder is configured to decode the video encoded information stream to obtain the video frames.

The depth information decoder is configured to decode the depth encoded information code stream to obtain the pieces of depth information.

In some embodiments, the at least one code stream is a hybrid encoded information code stream, and the decoder includes the video decoder.

The video decoder is configured to decode the hybrid encoded information code stream to obtain the video frames and the pieces of depth information.

In some embodiments, the image processor is further configured to adjust depths of field of the video frames based on the pieces of depth information, to obtain image frames with depth of field, and take the image frames with depth of field as the target image frames.

In some embodiments, when the pieces of depth information include pieces of phase information, the image processor is further configured to deblur, based on the pieces of phase information, the video frames to obtain deblurred image frames, and take the deblurred image frames as the target image frames.

In some embodiments, the decoding device further includes a depth image generator.

The depth image generator is configured to, after the at least one code stream is jointly or separately decoded to obtain the pieces of depth information and the video frames, generate depth images from the pieces of depth information.

In some embodiments, the decoder includes a video decoder, and the decoding device further includes a depth image generator.

The depth image generator and the image processor are independent of the video decoder, and the video decoder is connected with the depth image generator and the image processor. Alternatively, the depth image generator and the image processor are integrated in the video decoder. Alternatively, the depth image generator is integrated in the video decoder, the image processor is independent of the video decoder, and the video decoder is connected with the image processor. Alternatively, the image processor is integrated in the video decoder, the depth image generator is independent of the video decoder, and the video decoder is connected with the depth image generator.

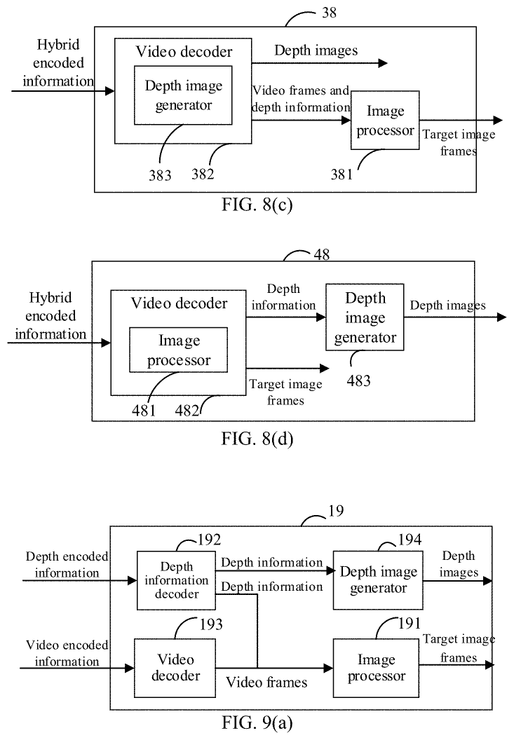

Exemplarily, as shown in FIG. 8(a), a schematic structural diagram of a decoding device is illustrated. The decoding device 18 includes an image processor 181, a video decoder 182 and a depth image generator 183. The depth image generator 183 and the image processor 181 are independent of the video decoder 182, and the video decoder 182 is connected with the depth image generator 183 and the image processor 181. The video decoder 182 is configured to process the pieces of hybrid encoded information and output the pieces of depth information and the video frames. The video decoder 182 transmits the pieces of depth information to the depth image generator 183. The depth image generator 183 processes the pieces of depth information, and outputs depth images. The video decoder 182 sends the video frames and the pieces of depth information to the image processor 181, and the image processor 181 performs image processing on the video frames based on the pieces of depth information, and outputs the target image frames.

Exemplarily, as shown in FIG. 8(b), a schematic structural diagram of a decoding device is illustrated. The decoding device 28 includes an image processor 281, a video decoder 282 and a depth image generator 283. The depth image generator 283 and the image processors 281 are all integrated in the video decoder 282. The video decoder 282 processes the pieces of hybrid encoded information and directly outputs the depth images and/or the target image frames.

Exemplarily, as shown in FIG. 8(c), a schematic structural diagram of a decoding device is illustrated. The decoding device 38 includes an image processor 381, a video decoder 382 and a depth image generator 383. The depth image generator 383 is integrated in the video decoder 382, the image processor 381 is independent of the video decoder 382, and the video decoder 382 is connected with the image processor 381. The video decoder 382 processes the pieces of hybrid encoded information, and outputs the depth images, the pieces of depth information and the video frames. The video decoder 382 sends the video frames and the pieces of depth information to the image processor 381. The image processor 381 performs image processing on the video frames based on the pieces of depth information, and outputs the target image frames.

Exemplarily, as shown in FIG. 8(d), a schematic structural diagram of a decoding device is illustrated. The decoding device 48 includes an image processor 481, a video decoder 482 and a depth image generator 483. The image processor 481 is integrated in the video decoder 482, the depth image generator 483 is independent of the video decoder 482, and the video decoder 482 is connected with the depth image generator 483. The video decoder 482 processes the pieces of hybrid encoded information, outputs the pieces of depth information and the target image frames. The video decoder 482 then sends the pieces of depth information to the depth image generator 483. The depth image generator 483 processes the pieces of depth information and outputs depth images.

In some embodiments, the decoder includes a depth information decoder and a video decoder, and the decoding device further includes a depth image generator.

The depth image generator is independent of the depth information decoder, the image processor is independent of the video decoder, the depth information decoder is connected with the depth image generator and the image processor, and the video decoder is connected with the image processor. Alternatively, the depth image generator is integrated in the depth information decoder, the image processor is independent of the video decoder, and the depth information decoder and the video decoder are connected with the image processor. Alternatively, the depth image generator is independent of the depth information decoder, the image processor is integrated in the video decoder, and the depth information decoder is connected with the depth image generator and the video decoder. Alternatively, the depth image generator is integrated in the video decoder, the image processor is integrated in the depth information decoder, and the depth information decoder is connected with the video decoder.

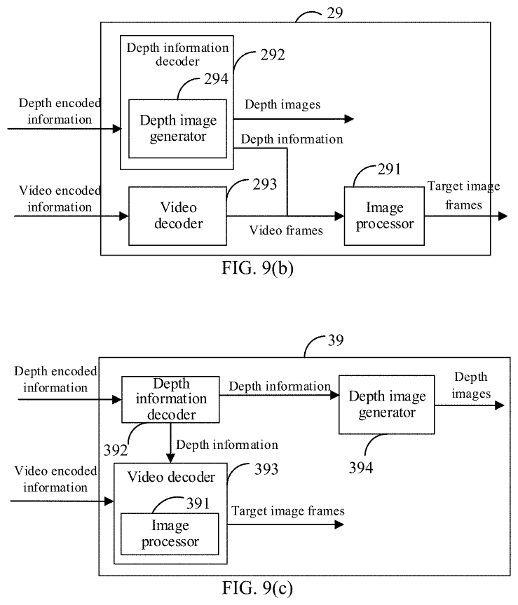

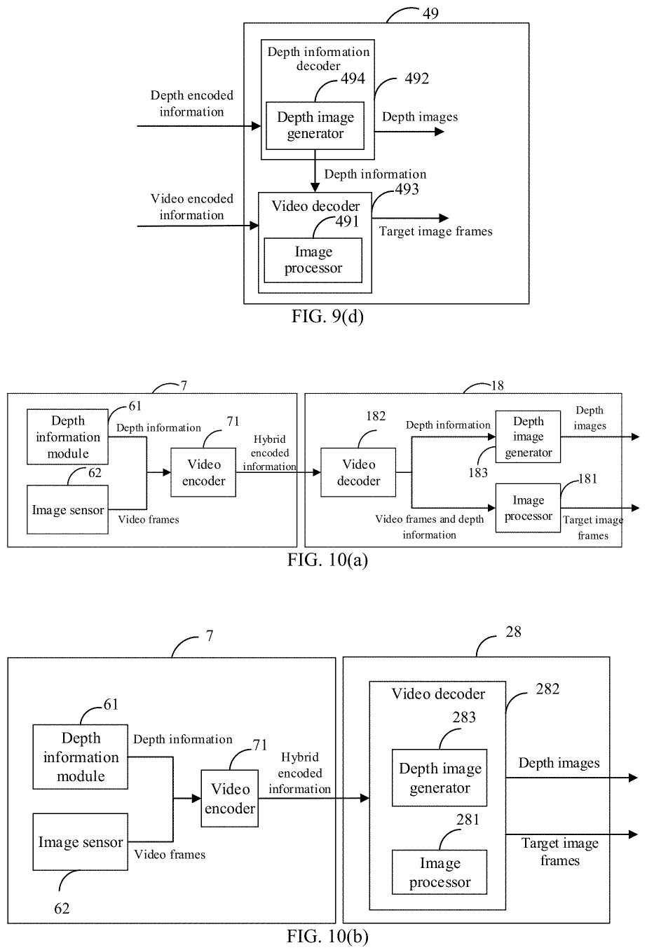

Exemplarily, as shown in FIG. 9(a), a schematic structural diagram of a decoding device is illustrated. The decoding device 19 includes an image processor 191, a depth information decoder 192, a video decoder 193, and a depth image generator 194. The depth image generator 194 is independent of the depth information decoder 192, the image processor 191 is independent of the video decoder 193, the depth information decoder 192 is connected with the depth image generator 194 and the image processor 191, and the video decoder 193 is connected with the image processor 191. The video decoder 193 processes the pieces of video encoded information and outputs the video frames. The depth information decoder 192 processes the pieces of depth encoded information and outputs the pieces of depth information. The video decoder 193 transmits the video frames to the image processor 191. The depth information decoder 192 transmits the pieces of depth information to the depth image generator 194 and the image processor 191. The depth image generator 194 outputs the depth images, and the image processor 191 outputs the target image frames.

Exemplarily, as shown in FIG. 9(b), a schematic structural diagram of a decoding device is illustrated. The decoding device 29 includes an image processor 291, a depth information decoder 292, a video decoder 293, and a depth image generator 294. The depth image generator 294 is integrated in the depth information decoder 292. The image processor 291 is independent of the video decoder 293. The depth information decoder 292 and the video decoder 293 are connected with the image processor 291. The video decoder 293 processes the pieces of video encoded information and outputs the video frames. The depth information decoder 292 processes the pieces of depth encoded information, and outputs the pieces of depth information and the depth images. The video decoder 293 transmits the video frames to the image processor 291. The depth information decoder 292 transmits the pieces of depth information to the image processor 291, and the image processor 291 outputs the target image frames.

Exemplarily, as shown in FIG. 9(c), a schematic structural diagram of a decoding device is illustrated. The decoding device 39 includes an image processor 391, a depth information decoder 392, a video decoder 393, and a depth image generator 394. The depth image generator 394 is independent of the depth information decoder 392. The image processor 391 is integrated in the video decoder 393. The depth information decoder 392 is connected with the depth image generator 394 and the video decoder 393. The depth information decoder 392 process the pieces of depth encoded information, and outputs the pieces of depth information. The depth information decoder 392 transmits the pieces of depth information to the depth image generator 394 and the video decoder 393. The depth image generator 394 outputs the depth images. The video decoder 393 outputs the target image frames based on the pieces of video encoded information and the pieces of depth information.

Exemplarily, as shown in FIG. 9(d), a schematic structural diagram of a decoding device is illustrated. The decoding device 49 includes an image processor 491, a depth information decoder 492, a video decoder 493, and a depth image generator 494. The depth image generator 494 is integrated in the depth information decoder 492. The image processor 491 is integrated in the video decoder 493. The depth information decoder 492 is connected with the video decoder 493. The depth information decoder 492 processes the pieces of depth encoded information, and output the pieces of depth information and the depth images. The depth information decoder 492 transmits the pieces of depth information to the video decoder 493. The video decoder 493 outputs the target image frames based on the pieces of video encoded information and the pieces of depth information.

The embodiments of the disclosure provide a computer-readable storage medium applied to the decoding device. The computer-readable storage medium stores one or more programs, and the one or more programs can be executed by one or more second processors. When executed by the second processor, the above information processing method performed by the decoding device is implemented.

The embodiments of the disclosure also provide an information processing system. The information processing system includes the encoding device and the decoding device. The encoding device includes a depth information module, an image sensor and an encoder. The decoding device includes an image processor and a decoder.

The depth information module is configured to collect the pieces of depth information.

The image sensor is configured to collects the video frames.

The encoder is configured to jointly or separately encode the pieces of depth information and the video frames to obtain pieces of encoded information, write the pieces of encoded information into at least one code stream, and send the at least one code stream to the decoding device.

The decoder is configured to, upon receiving the at least one code stream, jointly or separately decode the at least one code stream to obtain the pieces of depth information and the video frames.

The image processor is configured to perform image processing on the video frames based on the pieces of depth information to obtain the target image frames, and synthesize the target image frames into a video.

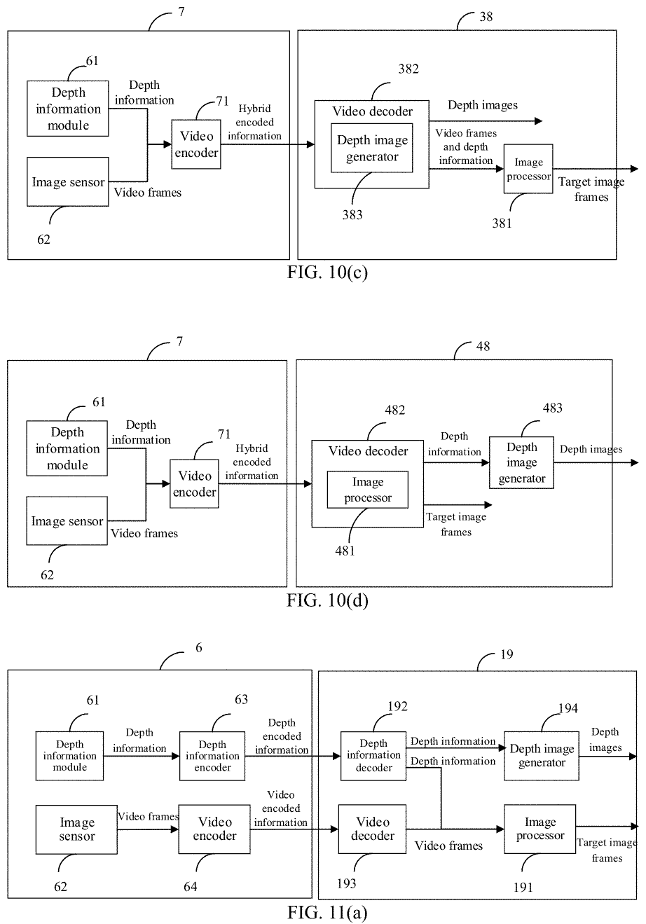

Exemplarily, as shown in FIG. 10(a), a schematic structural diagram of an information processing system is illustrated. The information processing system includes an encoding device 7 and a decoding device 18. The encoding device 7 includes a video encoder 71. The decoding device 18 includes an image processor 181, a video decoder 182 and a depth image generator 183. The video encoder 71 sends the pieces of hybrid encoded information to the video decoder 182. The video decoder 182 processes the pieces of hybrid encoded information, and outputs the pieces of depth information and the video frames. The depth image generator 183 processes the pieces of depth information, and outputs the depth images. The image processor 181 performs image processing on the video frames based on the pieces of depth information, and outputs the target image frames.

Exemplarily, as shown in FIG. 10(b), a schematic structural diagram of an information processing system is illustrated. The information processing system includes an encoding device 7 and a decoding device 28. The encoding device 7 includes a video encoder 71. The decoding device 28 includes a video decoder 282. The video decoder 282 includes a depth image generator 283 and an image processor 281. The video encoder 71 sends the pieces of hybrid encoded information to the video decoder 282. The video decoder 282 processes the pieces of hybrid encoded information and directly outputs the depth images and target image frames.

Exemplarily, as shown in FIG. 10(c), a schematic structural diagram of an information processing system is illustrated. The information processing system includes an encoding device 7 and a decoding device 38. The encoding device 7 includes a video encoder 71. The decoding device 38 includes an image processor 381 and a video decoder 382. The video decoder 382 includes a depth image generator 383. The video encoder 71 sends the pieces of hybrid encoded information to the video decoder 382. The video decoder 382 processes the pieces of hybrid encoded information and outputs the depth images, the pieces of depth information and the video frames. The image processor 381 performs image processing on the video frames based on the pieces of depth information, and outputs the target image frames.

Exemplarily, as shown in FIG. 10(d), a schematic structural diagram of an information processing system is illustrated. The information processing system includes an encoding device 7 and a decoding device 48. The encoding device 7 includes a video encoder 71. The decoding device 48 includes a video decoder 482, and a depth image generator 483. The video decoder 482 includes an image processor 481. The video encoder 71 sends the pieces of hybrid encoded information to the video decoder 482. The video decoder 482 processes the pieces of hybrid encoded information and outputs the pieces of depth information and the target image frames. The depth image generator 483 processes the pieces of depth information and outputs the depth images.

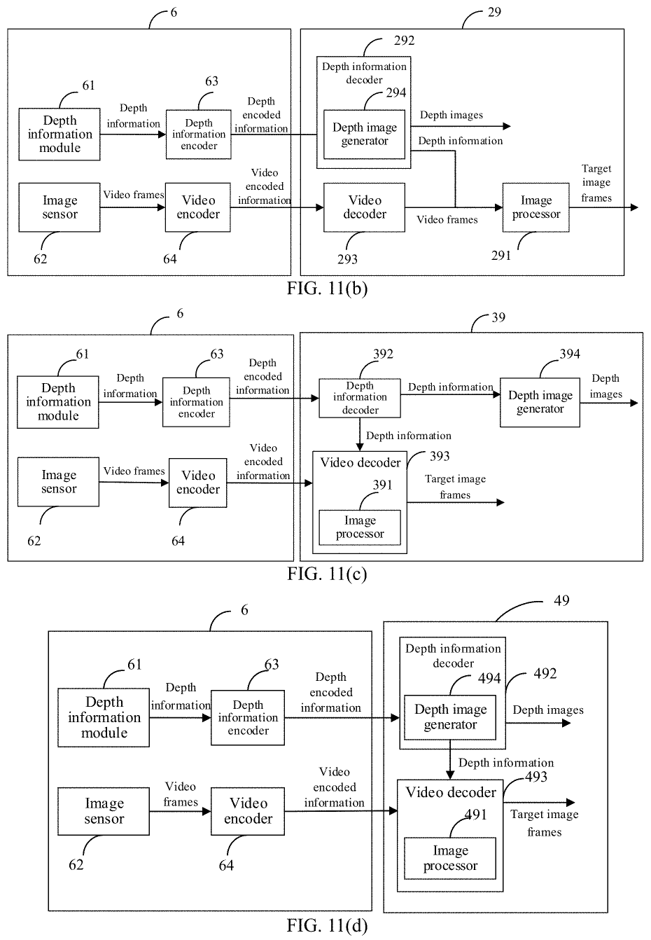

Exemplarily, as shown in FIG. 11(a), a schematic structural diagram of an information processing system is illustrated. The information processing system includes an encoding device 6 and a decoding device 19. The encoding device 6 includes a depth information encoder 63 and a video encoder 64. The decoding device 19 includes an image processor 191, a depth information decoder 192, a video decoder 193, and a depth image generator 194. The depth information encoder 63 sends the pieces of depth encoded information to the depth information decoder 192. The video encoder 64 sends the pieces of video encoded information to the video decoder 193. The depth information decoder 192 decodes the pieces of depth encoded information and outputs the pieces of depth information. The video decoder 193 decodes the pieces of video encoded information and outputs the video frames. The depth image generator 194 processes the pieces of depth information, and outputs the depth images. The image processor 191 performs image processing on the video frames based on the pieces of depth information, and outputs the target image frames.

Exemplarily, as shown in FIG. 11(b), a schematic structural diagram of an information processing system is illustrated. The information processing system includes an encoding device 6 and a decoding device 29. The encoding device 6 includes a depth information encoder 63 and a video encoder 64. The decoding device 29 includes an image processor 291, a depth information decoder 292 and a video decoder 293. The depth information decoder 292 includes a depth image generator 294. The depth information encoder 63 sends the pieces of depth encoded information to the depth information decoder 292. The video encoder 64 sends the pieces of video encoded information to the video decoder 293. The depth information decoder 292 processes the pieces of depth encoded information and outputs the depth images and the pieces of depth information. The video decoder 293 decodes the pieces of video encoded information and outputs the video frames. The image processor 291 performs image processing on the video frames by using the pieces of depth information, and outputs the target image frames.

Exemplarily, as shown in FIG. 11(c), a schematic structural diagram of an information processing system is illustrated. The information processing system includes an encoding device 6 and a decoding device 39. The encoding device 6 includes a depth information encoder 63 and a video encoder 64. The decoding device 39 includes a depth information decoder 392, a video decoder 393 and a depth image generator 394. The video decoder 393 includes an image processor 391. The depth information encoder 63 sends the pieces of depth encoded information to the depth information decoder 392. The video encoder 64 sends the pieces of video encoded information to the video decoder 393. The depth information decoder 392 decodes the pieces of depth encoded information, and outputs the pieces of depth information. The video decoder 393 processes the pieces of video encoded information and the pieces of depth information, and outputs the target image frames. The depth image generator 394 processes the pieces of depth information and outputs the depth image frames.

Exemplarily, as shown in FIG. 11(d), a schematic structural diagram of an information processing system is illustrated. The information processing system includes an encoding device 6 and a decoding device 49. The encoding device 6 includes a depth information encoder 63 and a video encoder 64. The decoding device 49 includes a depth information decoder 492 and a video decoder 493. The depth information decoder 492 includes a depth image generator 494, and the video decoder 493 includes an image processor 491. The depth information encoder 63 sends the pieces of depth encoded information to the depth information decoder 492. The video encoder 64 sends the pieces of video encoded information to the video decoder 493. The depth information decoder 492 processes the pieces of depth encoded information, and outputs the depth images and the pieces of depth information. The video decoder 493 processes the pieces of video encoded information and the pieces of depth information, and outputs the target image frames.

It should be noted that, when the depth information encoder in the information processing system encodes the pieces of depth information, and obtains multiple pieces of depth encoded information, one depth information encoder may be used to encode the multiple pieces of depth information to generate the multiple pieces of depth encoded information, and write the multiple pieces of depth encoded information into multiple code streams. Alternatively, multiple depth information encoders may be used to encode the multiple pieces of depth information to generate the multiple pieces of depth encoded information, and write the multiple pieces of depth encoded information into multiple code streams or one code stream. Alternatively, when the depth images and the pieces of remaining information are taken as the pieces of depth information, one depth information encoder may be used or multiple depth information encoders may be used to encode the depth images to obtain pieces of depth image encoded information, and write the pieces of depth image encoded information into one code stream, and then encode the pieces of remaining information to obtain pieces of remaining information encoded information, and write the pieces of remaining information encoded information into another code stream. Accordingly, one depth information decoder may be used to decode the multiple code streams, or multiple depth information decoders may be used to decode one code stream, or multiple depth information decoders may be used to decode the multiple code streams, which can be determined according to the actual situation, and is not limited in the embodiments of the disclosure.

It will be appreciated by those skilled in the art that the embodiments of the disclosure may be implemented as a method, device, system or computer program product. Accordingly, the disclosure may be implemented in the form of hardware, software, or combination of software and hardware. Furthermore, the disclosure may take the form of a computer program product embodied on one or more computer-usable storage media having computer-usable program codes therein (including but not limited to disk storage, optical storage, and the like).

The disclosure is described with reference to flowcharts and/or block diagrams of the methods, devices, systems and computer program products according to the embodiments of the disclosure. It will be understood that each process and/or block in the flowcharts and/or block diagrams, and combinations of processes and/or blocks in the flowcharts and/or block diagrams, can be implemented by computer program instructions. These computer program instructions may be provided to the processor of a general purpose computer, a special purpose computer, an embedded processor or other programmable data processing device to produce a machine, such that the instructions, when being executed by the processor of the computer or other programmable data processing device, produce means for implementing the functions specified in one or more processes of the flowcharts and/or one or more blocks of the block diagrams.

These computer program instructions may also be stored in a computer-readable memory capable of directing a computer or other programmable data processing devices to operate in a particular manner, such that the instructions stored in the computer-readable memory result in an article of manufacture including instruction means, where the instruction means implements the functions specified in one or more processes of the flowcharts and/or one or more blocks of the block diagrams.

These computer program instructions can also be loaded on a computer or other programmable data processing devices to cause a series of operational steps to be performed on the computer or other programmable devices to produce a computer-implemented process, such that the instructions implemented on the computer or other programmable devices provide the functions specified in one or more processes of the flowcharts and/or one or more blocks of the block diagrams.

The above descriptions are only preferred embodiments of the disclosure, and are not intended to limit the protection scope of the disclosure.

### INDUSTRIAL APPLICABILITY

The embodiments of the disclosure adopt the above technical solutions, in which the pieces of depth information are directly encoded to obtain pieces of encoded information containing the pieces of depth information, and the pieces of encoded information are sent to a decoding device. In this way, the decoding device can decode the pieces of encoded information to obtain the pieces of depth information and video frames. Thus, the decoding device can not only use the pieces of depth information to generate the depth images, but also use the pieces of depth information to perform image processing on the video frames, which improves the information utilization rate.

What is claimed is:

1. An information processing method, performed by an encoding device, the method comprising:
collecting pieces of depth information and video frames, wherein each piece of the depth information corresponds one of the video frames;
obtaining pieces of encoded information by encoding the pieces of depth information and the video frames; and
writing the pieces of encoded information into at least one code stream, and sending the at least one code stream to a decoding device, so that the decoding device performs image processing based on the pieces of encoded information.

2. The method as claimed in claim 1, wherein the collecting pieces of depth information and video frames comprises:
collecting the video frames within a preset period of time;
collecting, through a time-of-flight module or a binocular vision module, pieces of initial depth information within the preset period of time; and
taking the pieces of initial depth information as the pieces of depth information.

3. The method as claimed in claim 2, wherein after the pieces of initial depth information are collected, the method further comprises:
performing phase calibration on the pieces of initial depth information, and obtaining pieces of phase information; and
taking the pieces of phase information as the pieces of depth information.

4. The method as claimed in claim 2, wherein after the pieces of initial depth information are collected, the method further comprises:
performing depth image generation processing on the pieces of initial depth information to obtain depth image and pieces of remaining information, wherein the pieces of remaining information are other information, excepting the depth images, that are produced in the process of generating the depth images; and
taking the depths images and the pieces of remaining information as the pieces of depth information.

5. The method as claimed in claim 1, wherein the obtaining pieces of encoded information by encoding the pieces of depth information and the video frames, comprises:
obtaining pieces of encoded information by jointly or separately encoding the pieces of depth information and the video frames.

6. The method as claimed in claim 5, wherein the pieces of encoded information are pieces of hybrid encoded information, and the obtaining pieces of encoded information by jointly encoding the pieces of depth information and the video frames, comprises:
jointly encoding the pieces of depth information and the video frames based on a correlation between each of the pieces of depth information and a respective one of the video frames, to obtain the pieces of hybrid encoded information; or
encoding the video frames to obtain pieces of video encoded information, encoding the pieces of depth information to obtain pieces of depth encoded information, and adding each of the pieces of depth encoded information to a preset position of a respective one of the pieces of video encoded information, to obtain the pieces of hybrid encoded information.

7. The method as claimed in claim 5, wherein the pieces of encoded information comprise pieces of depth encoded information and pieces of video encoded information, and the obtaining pieces of encoded information by separately encoding the pieces of depth information and the video frames, comprises:
encoding the pieces of depth information to obtain the pieces of depth encoded information; and
encoding the video frames to obtain the pieces of video encoded information.

8. The method as claimed in claim 7, wherein the encoding the pieces of depth information to obtain the pieces of depth encoded information, comprises:
performing reduction processing on the pieces of depth information to obtain pieces of reduced depth information, wherein an amount of data of the pieces of reduced depth information is less than an amount of data of the pieces of depth information; and
encoding the pieces of reduced depth information to obtain the pieces of depth encoded information.

9. The method as claimed in claim 8, wherein the performing reduction processing on the pieces of depth information to obtain pieces of reduced depth information, comprises:
selecting, from the video frames, a part of video frames, and determining, from the pieces of depth information, a part of the pieces of depth information corresponding to the part of video frames; or
determining, from the video frames, at least one image position, and determining, from the pieces of depth information, a part of the pieces of depth information corresponding to the at least one image position; and
taking the determined part of the pieces of depth information as the pieces of reduced depth information.

10. The method as claimed in claim 8, wherein the performing reduction processing on the pieces of depth information to obtain pieces of reduced depth information, comprises:
performing redundancy elimination processing on the pieces of depth information based on a phase correlation of the pieces of depth information, a spatial correlation of the pieces of depth information, a temporal correlation of the pieces of depth information, a preset depth range, or a frequency domain correlation of the pieces of depth information, to obtain pieces of redundancy-eliminated depth information; and
taking the pieces of redundancy-eliminated depth information as the pieces of reduced depth information.

11. The method as claimed in claim 10, wherein the performing redundancy elimination processing on the pieces of depth information based on a phase correlation of the pieces of depth information, a spatial correlation of the pieces of depth information, a temporal correlation of the pieces of depth information, a preset depth range, or a frequency domain correlation of the pieces of depth information, to obtain pieces of redundancy-eliminated depth information, comprises:
when the pieces of depth information comprise at least two pieces of phase information, performing the redundancy elimination processing on the at least two pieces of phase information based on a phase correlation between the at least two pieces of phase information, to obtain the pieces of redundancy-eliminated depth information; or
when the pieces of depth information do not comprise the at least two pieces of phase information,
performing the redundancy elimination processing on the pieces of depth information based on the spatial correlation of the pieces of depth information, to obtain the pieces of redundancy-eliminated depth information; or
performing the redundancy elimination processing on the pieces of depth information based on the temporal correlation of the pieces of depth information, to obtain the pieces of redundancy-eliminated depth information; or
performing the redundancy elimination processing on the pieces of depth information based on the preset depth range, to obtain the pieces of redundancy-eliminated depth information; or
performing frequency domain conversion on the pieces of depth information to obtain pieces of frequency domain information, and performing the redundancy elimination processing on the pieces of frequency domain information based on the frequency domain correlation, to obtain the pieces of redundancy-eliminated depth information.

12. The method as claimed in claim 1, wherein after the pieces of depth information and the video frames are encoded to obtain the pieces of encoded information, the method further comprises:
eliminating bit redundancy of the pieces of encoded information based on a correlation between encoded binary data of the pieces of encoded information, to obtain pieces of redundancy-eliminated encoded information; and
writing the redundancy-eliminated encoded information into the at least one code stream, and sending the at least one code stream to the decoding device, so that the decoding device performs the image processing based on the redundancy-eliminated encoded information.

13. The method as claimed in claim 6, wherein the writing the pieces of encoded information into at least one code stream comprises:
writing the pieces of hybrid encoded information into one hybrid encoded information code stream.

14. The method as claimed in claim 7, wherein the writing the pieces of encoded information into at least one code stream comprises:
writing the pieces of depth encoded information into one depth encoded information code stream; and
writing the pieces of video encoded information into one video encoded information code stream.

15. The method as claimed in claim 1, wherein the collecting pieces of depth information and video frames comprises:
collecting first pieces of depth information and the video frames from at least one viewpoint; and
determining, from the at least one viewpoint, spaced viewpoints that are spaced from each other by one other viewpoint, and taking second pieces of depth information corresponding to the spaced viewpoints as the pieces of depth information.

16. An information processing method, performed by a decoding device, the method comprising:
upon receiving at least one code stream carrying pieces of encoded information, decoding the at least one code stream to obtain pieces of depth information and video frames, wherein each piece of the depth information corresponds one of the video frames; and
performing image processing on the video frames based on the pieces of depth information, to obtain target image frames, and synthesizing the target image frames into a video.

17. The method as claimed in claim 16, wherein the performing image processing on the video frames based on the pieces of depth information to obtain target image frames, comprises:
adjusting depths of field of the video frames based on the pieces of depth information, to obtain image frames with depth of field; and
taking the image frames with depth of field as the target image frames.

18. The method as claimed in claim 16, wherein when the pieces of depth information comprise pieces of phase information, the performing image processing on the video frames based on the pieces of depth information to obtain target image frames, comprises:
deblurring the video frames based on the pieces of phase information, to obtain deblurred image frames; and
taking the deblurred image frames as the target image frames.

19. The method as claimed in claim 15, wherein the decoding the at least one code stream comprises: jointly or separately decoding the at least one code stream; and
wherein after the at least one code stream is jointly or separately decoded to obtain the pieces of depth information and the video frames, the method further comprises:
generating depth images from the pieces of depth information.

20. An encoding device, comprising:
a depth information module, configured to collect pieces depth information;
an image sensor, configured to collect video frames, wherein each piece of the depth information corresponds one of the video frames; and
an encoder, configured to encode the pieces of depth information and the video frames to obtain pieces of encoded information, and send the pieces of encoded information to a decoding device, so that the decoding device performs image processing based on the pieces of encoded information.
